(19) United States
(12) Patent Application Publication
(10) Pub. No.: US 2015/0310697 A1
(43) Pub. Date: Oct. 29, 2015

(54) BEARER RAFFLE WITH ENHANCED SECURITY AND EXECUTION FEATURES

(71) Applicant: Sean O'Hagan, Saskatoon (CA)

(72) Inventor: Sean O'Hagan, Saskatoon (CA)

(21) Appl. No.: 14/686,173

(22) Filed: Apr. 14, 2015

(30) Foreign Application Priority Data
Apr. 22, 2014 (CA) 2847998
Dec. 2, 2014 (CA) 2872985

(51) Int. Cl. G07F 17/32

(52) U.S. Cl. CPC G07F 17/329; G07F 17/3237

(57) ABSTRACT

An improved ticketing system and method for bearer raffles. Upon sale of a bearer ticket, a purchasor identifier is captured at the raffle sales unit. The purchasor identifier is stored in a central ticket database along with the particulars of the bearer ticket sold. On completion of a raffle, raffle winners can be contacted using the captured purchasor identifier information, or in other cases winners can be looked up or verified if a ticket is lost.

This invention is in the field of bearer raffles, such as charitable 50/50 draws and the like, and electronic systems for the vending of such raffles, and more specifically provides an enhanced system for electronic vending, verification and redemption of such raffles.

### BACKGROUND

Lotteries and raffles are gaming concepts that are used in many contexts, to offer games of chance in certain circumstances as well as to provide profit opportunities or fundraising for the sponsors of such raffles or draws and the like.

A bearer raffle is a raffle type that takes place typically at an event or within a fixed timeframe, and in respect of which the sale of tickets or entries in the raffle is very straightforward. Tickets are typically just serial numbered, and sold from books, and a serial numbered ticket stub or counterfoil is drawn indicating the winner of the raffle at the appropriate time. The second type of a raffle or contest which is often used in these types of contests or fundraising programs is a longer-term raffle. Longer-term raffles quite often carry larger jackpots or prizes even including homes, vehicles or other similar merchandise, given the higher amount of resources and money at stake in these longer-term raffles, these often times require the capture of additional information for ticket purchasors including name, address and the like, rather than simply issuing a serial number counterfoil.

As outlined, the most common type of a bearer raffle is often also known as a “50/50 draw”. 50/50 draw raffle tickets are sold, the proceeds being aggregated. One or more winners are drawn when the ticket sales are closed, and the tickets drawn as the winners are entitled to participate in a profit share of the proceeds of ticket sales. A portion of the proceeds of the ticket sales also go to the sponsor or operator of such a bearer raffle.

As the popularity of raffles has increased there has been some innovation and development in the creation and deployment of electronic ticketing and administration systems for use with these types of raffles. There are a number of problems and lost opportunities in the prior art operation of these types of paper raffles or electronic bearer raffles. These include the fact that often the winning ticket is not claimed, as the winner was not at the event when the winner was announced. This is particularly true of multi-day progressive jackpot events. Similarly, a person will often not purchase a ticket since they would not be in attendance when the winner was announced. Beyond these issues around claiming of prizes and sales volume issues, insofar as a particular ticket is bearer ticket if the purchasor of the ticket lost it and someone else stole or found it, the true winner does not receive the jackpot.

As most of these bearer raffles are event-based, taking significant personal details of ticket purchasors to avoid or minimize some of these problems is time-consuming and problematic to do on a large scale in a short amount of time. As such, a bearer raffle most often does not have add-on longer-term raffle possibilities or perhaps the level of security or validation and integrity in the award process which might be desirable, since it is too time-consuming to capture a significant level of personal data from individuals purchasing tickets to allow for this.

The use of an electronic system to sell and issue the bearer tickets and administer the necessary data to allow for the conduct of such a raffle or draw provides for the ability to sell the tickets in larger volume at a rapid pace. The system overhead associated with administering a bearer raffle such as this at a large sporting event or in a large venue is far simpler to administer using electronic tools, and allows for less possibility of human error or cash leakage in the vending of tickets since there are fewer volunteers or human intervention required in the process.

The use of electronic ticket sales hardware and software also allows for some additional flexibility in terms of the type of bearer raffles or draws which can be delivered—in certain circumstances it may be desirable to conduct different types of raffles which include progressive proceeds or other side bets or side games, which can most easily be delivered using an electronic system but may be more difficult to administer with printed paper ticket books.

The electronic systems which have been developed for use in the sales of bearer tickets in these types of circumstances typically comprise a plurality of handheld raffle sales units, operatively connected by a communications network back to a central server and database. Tickets sales are conducted by operators of the raffle sales units, who use those terminals to issue the tickets which were desired to be purchased by a purchasor. For example, if a purchasor indicated that they wanted to buy five tickets, the operator of the raffle sales units can use that terminal to enter the number of tickets desired, and in certain circumstances select other options for example where multiple pricing levels or the like might also be available, and the raffle sales unit can then typically with a built-in printer print off a ticket stub for the purchasor and the operator will take their money or process payment using the terminal in a circumstance where credit card payment was taken in some cases.

Each ticket which is issued to a purchasor is serially numbered or identified, and the issuance of the unique tickets is tracked in a central administrative database to ensure that only unique ticket identifiers were used. As well, that central database is used to keep track of the identifiers of each ticket sold for the purpose of administering the actual raffle or draw.

When the ticket sales window for a bearer raffle or draw closes in a typical prior art system, the central database and server are used to print a series of paper counterfoils, which are the equivalent of the corresponding ticket stubs in a printed conventional ticket book. These counterfoils can be used to actually physically conduct the raffle or the draw. One counterfoil is created for each ticket which has been sold. There are a number of different variations on this basic type of system including the use of wired or wireless raffle sales units and other hardware and software in the system but this is the general background to electronic sales systems to date in this area.

One of the limitations of the current state electronic sales systems used in bearer raffles or draws is the fact that no identifying information of ticket purchasors is captured. Either in the case of a basic paper-based raffle or even using these types of electronic systems what is typically done is the ticket numbers or identifiers are issued to a purchasor, the purchasor gives the operator the money for the tickets, and when the draw is conducted the purchasor is obligated to physically compare their ticket stub or purchase receipt including their purchased tickets numbers or identifiers to the announced winning numbers for the purpose of ascertaining if the participated in any winnings in the raffle or draw. Failure to capture any identifying information of ticket purchasors might be less desirable from a marketing perspective as well.

If someone loses their physical ticket stub they are unable to either assess whether or not they are a winner, and/or to claim their prize without their ticket. It would be preferable if there were a way to somehow expeditiously identify the purchasors of winning bearer tickets in bearer raffles or draws at the time of the sale of those tickets, for the purpose of providing an added level of security and validation to the operators of the system as well as the participants if a ticket is lost or other verification is required.

In addition to data capture resulting in added flexibility and validation possibilities in the administration of bearer raffles in accordance with this or other similar inventions, it would be most desirable to provide a means by which added information regarding a purchasor could be captured and stored for future use in the sales of tickets in similar raffles. By capturing additional identifying information with respect to ticket purchasors, a centralized marketing database can be assembled, and the fundraising entities could use the purchasor information captured in respect of tickets sales and purchasors to perhaps market future raffles, and otherwise communicate with stakeholders of their organizations. As such it would be desirable to come up with a bearer raffle ticketing system which allowed for the reasonably streamlined capture and use of additional purchasor with respect to ticket purchasors, such as names, addresses, communication details and the like.

The second type of raffle as outlined above, namely longer-term raffles which typically have larger prizes and the like and which are typically sold over a longer time window than for example a bearer raffle such as an event-based 50/50 draw etc., typically require the capture of additional purchasor information. Capturing the information in the context of the sales of bearer tickets, or in the context of add-on or longer-term raffles or draws, would allow for the population of a database that contained necessary purchasor particulars and information which would allow for streamlined sales of both types of raffle or draw tickets. If it were possible to collect the necessary information for population of ticket records or sales of tickets of both types in a single consolidated system, additional possibilities could be created in terms of the sale of different types of raffles or fundraising draws. It might even be the case for example that with the necessary changes to a ticketing system that both bearer raffles and longer-term raffles could be sold in a single ticketing process, which is the intention and target of the present invention.

### SUMMARY OF THE INVENTION

In order to overcome limitations in the prior art, the present invention provides an improved system and method for the conduct and administration of a bearer raffle which presents advantages over prior art ticketing raffling systems insofar as it removes the anonymous nature of the raffle by gathering a purchasor identifier during ticket sales. By gathering a purchasor identifier, and/or other additional details from a purchasor, in the sale of a bearer ticket and a bearer raffle, an added layer of flexibility, security and verification can be added to the process as well as providing additional enhanced customer feedback and marketing opportunities by the collection of additional purchasor data.

The method of the present invention comprises a method of conducting a bearer raffle which first provides a ticketing server hosting a ticket database comprising a plurality of ticket records, each of which corresponds to a bearer ticket sold in a bearer raffle. Each ticket record would include a unique ticket identifier, or a serial number of sorts, a purchasor identifier corresponding to the purchasor of the bearer ticket, and ticket parameters for the bearer tickets sold. The ticket parameters of bearer tickets might include prices, side bet parameters and the like. The ticketing server would also contain the necessary software components to interface with or administer the ticket database, create and access ticket records therein and the like. The ticketing server would also include a ticketing network interface for communication with at least one raffle sales unit. The ticketing network could either be a wide area or local area network or a proprietary network, and the interface to that network on the ticketing server would be the ticketing network interface.

Raffle sales units would be the actual hardware terminals used by operators to sell bearer tickets in the bearer raffle, in one or more venues, in accordance with the remainder of the method of the present invention. Raffle sales unit in respect to a single bearer raffle could be located in one or more venues, and changes in that aspect of the architecture of the system of the present invention could be incorporated or accommodated in the network design of the system. The raffle sales units are the hardware devices which would be used by operators in the sales of bearer ticket in accordance with the method of the present invention. Each raffle sales unit would comprise an operator interface, by which an operator could interact with the remainder of the raffle sales unit, as well as with the ticketing server via the ticketing network, a network interface which was in communication with the ticketing server via the ticketing network, and raffle sales software for operators to actually transact the generation and sale of bearer tickets to purchasors. Generally speaking in client server deployment, the software and interface of the raffle sales unit would provide the sales interface through which operators could sell tickets to purchasors during a predefined sales window for a particular bearer raffle.

In addition to the ticket database and the ticketing network interface, the ticketing server would also comprise ticketing server software for administering the ticketing database and managing communications via the ticketing network interface with the raffle sales unit. The ticketing server software could be of varying degrees of complexity and approach, all of which would be understood to those skilled in the art of program design and client server software systems and all of which are contemplated herein. The general functionality achieved by the ticketing server software component or components would be the receipt of sold ticket parameters from raffle sales unit via the ticketing network interface, the creation and storage of ticket records in the ticketing database corresponding to bearer tickets sold at the raffle sales units, as well as potentially enabling or achieving the selection of winning tickets and communicating with purchasors of tickets via an optional purchasor network interface.

Following provision of a ticketing server and ticketing database, along with at least one raffle sales unit as outlined, the method would comprise actually selling bearer tickets in a bearer raffle during a defined sales window. A bearer raffle would have a defined sales window extending within a particular event or a particular period of time and following the expiry of that defined sales window when bearer ticket is chosen. During that defined sales window, the sale of bearer tickets in the bearer raffle in accordance with the method of the present invention would comprise a number of steps with respect of each bearer ticket sold. Firstly, using a raffle sales unit, an operator could select ticket parameters for the bearer ticket to be sold—for example pricing levels, side bets or other parameters to the sale of the bearer ticket as well as the number of bearer tickets being sold in a transaction, as well as capturing a purchasor identifier in respect of the purchasor of the ticket.

The purchasor identifier might be a communications address—SMS number, email address, phone number, etc.—or it could be some type of a serial identifier assigned to that purchasor in accordance with the remainder of the method of the present invention. The purchasor identifier would be associated with the bearer ticket or tickets served in the transaction and any event, for the purpose of not only providing validation and communications capability with the purchasor of the ticket if that ticket was selected as a winner but also to provide potential additional marketing capabilities in accordance with the larger of the method of the present invention. It is specifically contemplated that the purchasor identifier could be any type of a communications address or other token which could be used to identify and/or optionally communicate with purchasors via purchase network interface of the ticketing server, or in a traditional or conventional communications fashion.

In addition to allowing an operator of the raffle sales unit to select ticket parameters and capture a purchasor identifier, the issuance of a bearer ticket by the raffle sales unit would comprise the association or assignment of a unique ticket identifier to that bearer ticket being sold so that that could be stored and associated with the bearer ticket sold in the related ticket record which would be created in the ticketing database. Various types of software can be conceived which would allow for network communication and the generation or association of unique ticket identifiers either at the raffle sales unit or at the server—the unique ticket identifiers might be unique to the raffle sales unit itself or unique to the entire raffle and defined sales window—the concept of keying a database and the assignment of unique record identifiers and database applications would be understood to those skilled in the art of database programming.

Finally, following or in conjunction with the association of a unique ticket identifier, the raffle sales unit would transmit the ticket parameters captured, the purchasor identifier captured and the assigned ticket identifier, which together represent sold ticket particulars, to the ticketing server.

The ticketing server's receipt of a particular packet related to a set of sold ticket particulars transmitted thereto from a raffle sales unit, locally within the venue or remotely if the ticketing server is further located from the venue in which sales are taking place, would trigger the creation by the ticketing server software components of a ticket record in the ticketing database in respect of each set of sold ticket particulars received.

Following the closure of the defined sales window for a bearer raffle, a winning ticket record would be selected from the ticket records related to the particular bearer raffle which are stored in the ticketing database, and using the associated purchasor identifier from the selected winning ticket record the purchasor of the ticket can be identified for the sake of notification, award, validation, etc.

Notification of the purchasor of the winning ticket associated with a winning ticket record, or even notification of all purchasors of tickets within a particular bearer raffle, could take place in some embodiments of the system of the present invention where the ticketing server included one or more purchasor network interfaces automatically by the transmission of notification of the status of the winning of the raffle etc. to the communications device of the purchasors using the purchasor identifiers captured to the ticket records. Alternatively in some more traditional embodiments, or in cases where the server did not include one, or all of the necessary, purchasor network interfaces, traditional or prior art communication methods could be used, using the purchasor identifier captured in relation to a ticket record, to notify the winner or all of the participants in a particular bearer raffle of the outcome or status of same.

To streamline data capture and data entry at the raffle sales unit it is specifically contemplated that the raffle sales units might either include a touch screen, keyboard or the like by which a human interface could be allowed to enter the purchasor identifiers when needed to be captured, or in other embodiments, the raffle sales unit might actually include a scanner which could be used to scan a physical identifier of the purchasor for the purpose of identification, validation or a later communication—for example a credit card, driver's license or other piece of identification, where the raffle sales software on the raffle sales unit could extract or recognize by optical character recognition or otherwise the purchasor identifier or other information which would be needed for the sake of fulfillment of the steps of the method.

Where a ticket is sold by the operator of a raffle sales unit, the raffle sales unit might either directly or via communication on the ticketing network to the server, print a receipt for physical provision to the purchasor of the ticket which identified the ticket numbers and other particulars thereof, or in the case where the purchasor identifier captured from a purchasor and stored to the ticket record in respect of a particular bearer ticket was a communications address, the system might also transmit a receipt or the details of the ticket purchased or electronically to the communications device the purchasor using the purchasor identifier or other information captured during the sale to address such a transmission.

As outlined elsewhere herein, the selection of the winning ticket record itself could take place either by a random ticket record selection accomplished using a random number generator on the ticketing server to randomly and electronically select a winning ticket record from the active ticket records in the ticketing database with respect to a particular bearer raffle, or alternatively another approach to random winner selection could be to facilitate an actual physical or manual selection of a winning ticket by printing counterfoils with respect to each active ticket record in respect of the raffle in the ticketing database, which could then be used to conduct a manual or physical draw. Both such approaches are contemplated herein. The method of the present invention would allow for the selection of a winning ticket record to be made from all of the ticket records in the ticketing database in respect of a particular bearer raffle, or in the case that some aspect of the raffle was a side bet, optional or otherwise, the winning ticket could be selected from a subset of active ticket records in the ticketing database with respect to a bearer raffle, based on the ticket parameters stored in those records.

The method might also comprise, during the opened defined sales window for the bearer raffle in question, displaying a total amount of raffle proceeds available to be awarded on at least one public display device operatively connected to the ticketing network interface—this would be basically be similar to what is done in some current state 50/50 draws and hardware systems, whereas the jackpot increases, the amount of available proceeds is displayed within the venue to drive interest and participation. This again would be done in conjunction with the remainder of the method including the capture of a purchasor identifier with respect to ticket purchases. In the case that the ticketing server contained one or more purchasor communication network interfaces and the purchasor identifiers captured in respect of some or all of the ticket records in respect of the bearer raffle stored in the ticketing database were communications addresses, the method might also comprise providing one or more transmitted notifications of the approaching closure of the ticket purchase period to other purchasors who have previously bought other tickets which might drive additional purchases in the draw.

A final enhancement which is contemplated would be the issuance of validation code in respect of tickets sold. The validation code could be entered by the operator of a raffle sales unit, or generated automatically by the software of the system and stored to the ticket record in the ticketing database in respect of a ticket sold, so that when a purchasor was contacted to be advised of their having purchased the winning ticket and being the purchasor of the winner ticket record in a particular bearer raffle, they could be asked to furnish the corresponding validation code to confirm that they were in fact the proper winner of the raffle. Many different approaches to this type of validation concept could be conceived and again all are contemplated within the scope of the present invention.

Another aspect of the present invention is the optional ability to capture additional purchasor data in respect of a ticket purchasor in respect of a bearer ticket or other tickets sold, in addition to the purchasor identifier, for storage and association with the sold ticket particulars and the corresponding ticket record. In some embodiments of the method of the present invention, the step of selling a bearer ticket via a raffle sales unit further comprises capturing additional purchasor data in respect of the purchasor of the ticket via the operator interface of the raffle sales unit. The additional purchasor data which might be desired to be captured might be additional data which was desired to be capture for marketing purposes or alternatively as is outlined elsewhere below, if additional purchasor data was required with respect to the sale of particular side bets or add-on raffles at the same time as the primary bearer ticket sale. Embodiments of the system and method of the present invention which would allow for streamline capture and maintenance of additional purchasor data would likely include a purchasor database or data set within the ticketing database and will again be understood to those skilled in the art of database design.

It is specifically contemplated that the method of the present invention could also provide the ability for an operator of a raffle sales unit to sell one or more tickets in additional bearer raffles or non-bearer raffles to a purchasor at the time of selling a primary bearer ticket. Additional longer-term add-on raffles and non-bearer raffles could be facilitated for sale along with bearer ticket in accordance with the method of the present invention by allowing for the selection of additional ticket sales and the related creation of additional related ticket records in the ticketing database in respect of additional tickets sold. This would provide significant marketing benefit or ability for the operator of the bearer raffle to maximize their capture of revenue, etc. The add-on raffles which could be sold along with a bearer ticket in relation to the primary method of the present invention could be tickets in one or more additional bearer raffles such as side bets or the like, or could alternatively be a non-anonymous longer-term raffle. The optional sale of at least one add-on ticket would be selectable and fulfillable by the raffle sales unit and its operator.

Some embodiments of the method might not require any additional purchasor data to be captured from the purchasor beyond the purchasor identifier in respect of the bearer raffle itself or in respect of one or more add-on raffles. In other embodiments, additional purchasor data might be desired or required to be captured in respect of a bearer raffle or an add-on sale either for regulatory purposes or even just for internal business purposes by the operator of the raffle to capture and validate as much information as possible to ensure a complete marketing database.

If additional purchasor data was required to be captured in respect of a bearer raffle it might either be the same additional purchasor data which was required in respect of at least one add-on raffle, or the additional purchasor data which was required might be different for the different types of raffles or add-ons which were being sold in accordance with the same step and embodiment of the method of the present invention.

In addition to the overall method of the present invention there is also disclosed ticketing server software as well as raffle sales software which could be used on a ticketing server or on at least one raffle sales unit to deploy the method of the present invention. It is explicitly contemplated that the software for use on the ticketing server as well as on the raffle sales units could be created in a way that pre-existing hardware systems for the sale of bearer tickets on venues could be retrofitted with the software and the method of the present invention to allow of execution of raffles in accordance with the remainder of the method outlined herein, or alternate embodiments of the software components could be created which would allow for the maximum use of the configuration and capabilities of new purpose-built hardware.

The ticketing server might include one or more purchasor network interfaces—the purchasor network interface is contemplated to be a communications interface by which the ticketing server or the overall system of the present invention could communicate with the communications devices of one or more purchases of bearer tickets, where the purchasor identifier captured from a purchasor was an address which was capable of being used for communication on that communications network interface—for example the purchasor network interface might be an SMS interface and the purchasor identifier captured from purchasors on the system might be SMS addresses, or alternatively or in addition, an additional communications network interface for communication with purchasors might be an email gateway, voice telephone number system or the like. It would be understood that one or more purchasor communication network interfaces could be included in the ticketing server and all such approaches are contemplated within the method of the present invention.

The notification regarding the closure of a bearer raffle and the selection of a winning ticket record could either comprise communication by transmission via a communications gateway, or in traditional context, of a winning notification to the winning purchasor, using the purchasor identifier stored within the winning ticket record, or in other approaches and embodiments, all of the ticket purchasors in a particular raffle could be notified of the outcome. Both such approaches are contemplated within the scope of the present invention.

The ticketing server of the present invention might be located in a venue within which a bearer raffle was being conducted, or a particular bearer raffle might be conducted using raffle sales units and network hardware located in multiple venues and a single ticketing server could receive the sold ticket parameters therefrom. In addition to allowing for multiple venue single bearer raffles, the method of the present invention also contemplates the use and development of a ticketing server which could receive sold ticket parameters from multiple raffle sales units in respect of multiple bearer raffles in multiple venues—by simply identifying the sold ticket parameters in this way, a consolidated central ticketing service could also be created which would allow for the streamlined conduct of bearer raffles by multiple operators in multiple venues.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numerals, and where:

FIG. 1 is a flowchart demonstrating the basic steps in one prior art embodiment of a method of conducting a bearer raffle, for illustrative purposes;

FIG. 2 is a flowchart demonstrating the basic steps in one embodiment of the enhanced bearer ticket sales method of the present invention;

FIG. 3 is a schematic diagram of one embodiment of a system architecture in accordance with the present invention;

FIG. 4 is a schematic drawing of one embodiment of a ticketing server in accordance with the present invention;

FIG. 5 is a schematic figure, showing one embodiment of a ticket database in accordance with the present invention;

FIG. 6 is a schematic drawing of the key components of one embodiment of a raffle sales unit in accordance with the present invention;

FIG. 7 is a flowchart of an alternate embodiment of the method of the present invention in which a validation code is assigned to tickets sold;

FIG. 8 is a flowchart of an alternate embodiment of the method of the present invention in which additional purchasor data is captured based on validation of the purchasor identifier;

### DETAILED DESCRIPTION OF THE INVENTION

As outlined above the general focus of the present invention is to provide an enhanced system and method of bearer raffle sales and fulfillment. By capturing a purchasor identifier, which is a communications address such as a telephone number or email address by which notifications in respect of the ticket purchased can be dispatched, at the time of sales of the ticket, enhanced sales ability as well as enhanced security and flexibility in the raffling process is provided.

### Prior Art—Bearer Raffles:

Charitable raffles are governed by the regulatory bodies in the jurisdictions of which they reside, be those states, provinces or counties. Rules may vary in the regulatory body often has terms and conditions on charitable raffle publications on their websites. For the purpose of illustrating the method of the present invention, we provide the following example of a basic bearer ticket 50/50 raffle and a summary of how to play the game which is presented for foundational purposes. As will be outlined elsewhere herein, the specifics of the nature of playing the actual raffle or game underlying the method of the present invention can vary and the description of this one embodiment should not be considered to be limiting of the overall subject matter of the present invention in this application.

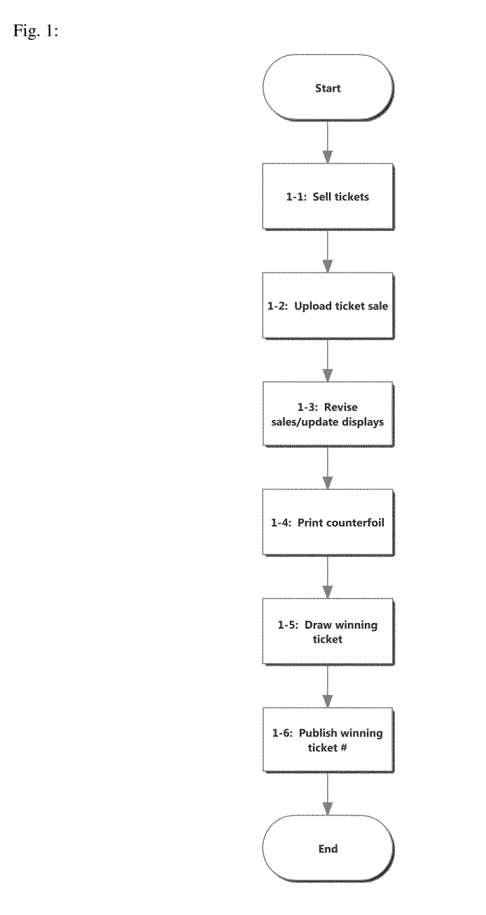

Referring to FIG. 1 there is shown a flowchart demonstrating a high-level understanding of one prior art method of the conduct of a bearer raffle, using an electronic ticket sales system. A player would desire to purchase one or more tickets in the raffle, each up and having several options on the pricing of tickets and number of drawn numbers. This style of ticket is often known as a discount ticket. The ticket numbers or identifiers in respect of these tickets might be sequential or random but are uniquely generated. Unique validation numbers are generated for each ticket sold to verify the winning ticket. A ticketing machine which is operatively connected to a server hosting a ticket database and system software is used in this method to sell tickets to the purchasor.

The ticketing machine has an operator interface by which tickets can be sold. The sale of tickets is shown at step 1-1 in this Figure. Typically what would happen in this sale step would be that the operator of the ticketing machine would use the operator interface to enter the selected parameters for the ticket sale desired by the purchasor—for example the number of tickets to be purchased, or in certain cases selecting pricing options, number of drawn numbers etc. Based on input from the operator, the ticketing machine would generate the tickets for sale and would print out a ticket slip with the details of the tickets sold. The operator would then take the money in respect of those tickets from the purchasor and the purchasor would retain the ticket slip for the purpose of subsequently claiming their prize.

As outlined above each “ticket” which was sold would comprise a unique ticket identifier in respect of the ticket. This could be a serial identifier or could be randomly generated as outlined above, and could be generated by the server and communicated to the ticketing machine at the time of the generation of the sale or in an embodiment of the method and system of this prior art approach which had the ticketing machines operating off-line for intermittent or periodic connection and update with the server and the ticket database, the software on the ticketing machine might also be responsible for the generation or selection of the unique ticket identifiers in respect of each ticket sold. The ticket identifiers in respect of each sold ticket would be stored to the memory of the ticket machine and eventually uploaded to the ticket database on the server. In addition to the unique ticket identifiers in respect of each ticket, the ticket machine would also store the other details of each ticket sold—for example the price, selected drawn number parameters etc.—so that all of those could be stored back to the central ticket database in respect of each ticket sold.

In terms of the issuance of a ticket stub or receipt, the ticket machine might issue a single ticket stub per sale, even when a ticket sale to a purchasor comprise the sale of more than one ticket, or it might issue a separate ticket stub or receipt in respect of each ticket sold.

Following the purchase of a ticket from the operator of a ticket machine in accordance with this method, shown at step 1-1, the ticket machine would upload the details of that ticket sale to the central ticket database. This is shown at step 1-2. As outlined above, it may be the case that each ticket machine in a particular deployment of the system would be actively and constantly connected to the server and the central ticket database so that the details of ticket sales would be uploaded on a real-time basis, or alternatively in other circumstances for example where the ticket machines were wirelessly connected and were in a environment in which there was not a steady or reliable wireless connection, the software on the ticket machine to allow for “off-line” sales with a periodic synchronization taking place with the ticket database.

Many electronic bearer ticket systems which currently exist also provide periodic updates either to the operators of the bearer raffle, or even to spectators within the venue by way of electronic displays or the like, of the current value of the proceeds to be one in the raffle etc. On an ongoing basis as ticket sales were uploaded to the ticket database in these prior art methods, shown at step 1-2, running totals would be revised on a periodic basis and could be either displayed to the operator or displayed by the hardware of the present invention are communicated elsewhere in the display system within a venue to provide updated display totals. This is shown at step 1-3. Some embodiments of prior art electronic bearer raffles would not have venue displays showing the current raffle total amount—this step is shown in this flowchart simply to demonstrate the general current state-of-the-art.

Either during the open sales window for the sales of tickets in this bearer raffle, or at the close of the sales window, a counterfoil would be printed in respect of each ticket which had been sold, with the ticket identifier which could either be the unique ticket ticket identifier or some other token to identify the ticket. These counterfoils would be printed for placement into a draw drum so that a traditional manual drawing of a winning ticket number could be conducted. Printing of the counterfoils, which could take place on an ongoing basis during the open sales window for tickets in the bearer raffle or at the close of the sales period is shown at step 1-4. Alternatively, if it was desired to electronically select the winner of the bearer raffle without the printing of counterfoils, a random number generator could also be used to produce the winning ticket number or ticket identifier, based on the details of validly sold tickets stored within the central ticket database. Both such approaches will be understood to those skilled in the art of the design and delivery of the systems.

The next step shown in the prior art method outlined in this Figure is the drawing of a winning ticket. The drawing of a winning ticket, shown at step 1-5 would comprise the physical drawing of a counterfoil from the batch of counterfoils which have been printed corresponding to all sold tickets. In some raffles more than one winning ticket would be chosen and this would require the selection of more than one winning counterfoil. Following the drawing of the winning ticket, shown at step 1-5, the winning ticket number would traditionally be published or announced, shown at step 1-6. This Figure demonstrates the general method that is involved in electronically deployed bearer raffle, and the general state of the art against which the improvements of the present invention can be understood and compared.

### Assignment of Purchasor Identifier to Ticket Records:

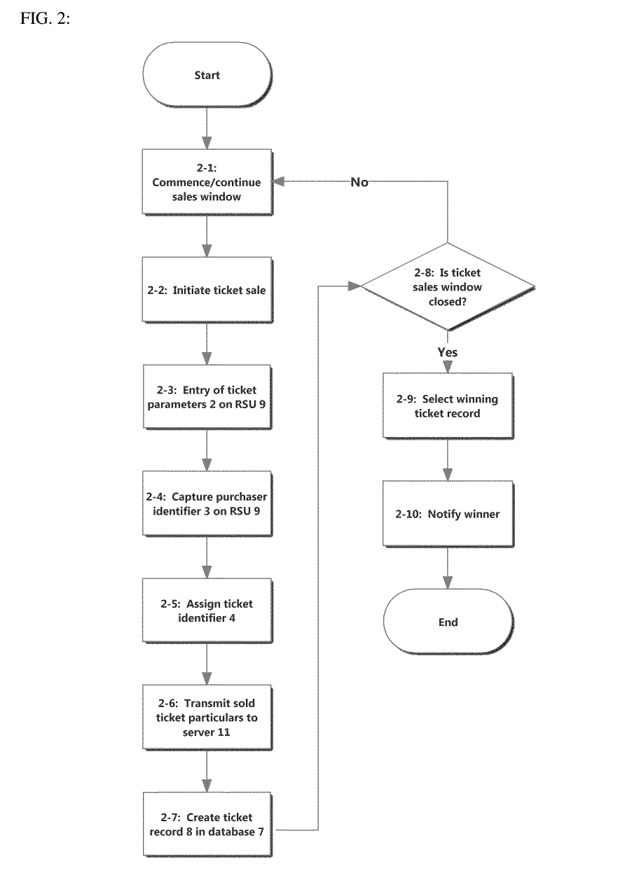

FIG. 2 is flowchart which shows the steps involved in one basic embodiment of a method in accordance with the present invention, which uses the combination of a ticketing server 11 and the plurality of raffle sales units 9 as outlined herein. The first step in the method, shown at 2-1, is the commencement of a raffle sales window in accordance with the method of the present invention. As outlined in the claims and the remainder of the document herein, tickets for a bearer raffle are typically sold within a defined sales window at a venue or the like. The opening or commencement of that ticket sales window is shown as the first step, following which ticket sales can take place.

During the ticket sales window, bearer tickets will be sold to purchasors. Tickets would be sold to purchasors using raffle sales units 9 during the ticket sales window—the ticket sales window is shown opening or continuing at step 2-1 in this figure. There would be the initiation or completion of ticket sales transactions within that window. The commencement of a particular bearer ticket sales transaction is shown at step 2-2. When a purchasor wished to purchase a bearer ticket from a ticket sales operator, the ticket sales operator using one of the raffle sales units 9 would initiate the creation of the sale transaction. The operator of the raffle sales unit 9 would enter any required ticket parameters 2 on the device 9. The ticket parameters 2 might include the price, selection of side bets or conditional variables for use on the draw, etc. The entry of the ticket parameters 2 on the raffle sales unit 9 is shown at step 2-3.

In addition to the entry of any other ticket parameters 2 on the raffle sales unit 9, the operator would also need to enter or capture a purchasor identifier 3 on the terminal 9. Capture of the purchasor identifier 3 is shown at step 2-4. The capture of a purchasor identifier 3, which is either a communications-based address or other unique indicator of the purchasor, by which the security, validation and flexibility features of the method of the present invention can be enabled, is the distinguishing feature of this bearer raffle over the prior art. The purchasor identifier 3 could be captured on the raffle sales unit 9 either by manual data entry, scanning or the like. The nature of the purchasor identifiers 3 as well as the raffle sales unit 9 and the types of hardware which could be used to capture the purchasor identifier 3 are outlined in further detail elsewhere herein.

Following the capture of any other ticket parameters 2 and a purchasor identifier 3, the software on the raffle sales unit 9 would transmit the ticket parameters 2, the purchasor identifier 3 as well as an assigned unique ticket identifier 4 which was assigned to the transaction, which in total make up the sold ticket particulars, to the ticketing server. Payment would be collected and potentially a receipt for the ticket including the ticket identifier or other information would be issued to the purchasor. Assignment of the unique ticket identifier 4 is shown at step 2-5, and the transmission of the sold ticket particulars from the raffle sales unit 9 to the server 11 is shown at step 2-6.

The assigned unique ticket identifier 4 could either be generated and assigned by the raffle sales unit software, or by the software on the ticketing server and transmitted to the raffle sales unit or assigned to the remainder of the sold ticket particulars as that transmission or packet is received by the ticketing server from the raffle sales unit. All such approaches of serializing the transmissions and ticket records and ticket database are contemplated within the scope of the present invention.

On the ticketing server, a ticket record 8 would be created in the database 7 upon receipt by the server 11 of a packet or transmission of sold ticket particulars. The specifics of the ticket record 8 are outlined elsewhere herein, and the necessary software components for such a function on the ticketing server 11 will be understood to those skilled in the art of database programming and design.

The availability of bearer tickets for sale through sales transactions such as this would continue throughout the ticket sales window. This Figure shows at step 2-8 a decision block which would determine the length of time in which the listening loop for receipt of sold ticket particulars would take place on the server 11 and/or that the raffle sales units 9 would be authorized to issue tickets for sale. Following the expiry of the ticket sales window, the raffle sales units 9 and the server 11 would not be able to issue any more tickets for sale.

The raffle sales units 9 could either work in a connected or networked client server fashion, to transmit sold ticket particulars to the server 11 on an ongoing basis as the transactions were completed, or alternatively if the raffle sales units 9 were working in an offline or disconnected mode from the ticketing network interface and the ticketing server 11, the sold ticket particulars could be stored to the memory of the raffle sales unit 9 until there was a network connection to the ticketing network, and to the ticketing server 11 for the purpose of transmitting the sold ticket particulars to the server 11 for the creation of ticket records 8 in the ticket database 7.

Following the expiry or closing of the raffle sales window, a winning ticket record 8 would be selected from the ticket database 7, based upon a selected set of active ticket records 8 pertaining to the raffle in question in the ticket database 7. This is shown at step 2-9. Following the selection of a winning ticket record 8, the winner or owner of the ticket represented by that ticket record 8 could be notified—shown at step 2-10. Notification of the owner of the winning ticket, or of everyone who purchased a ticket in the particular bearer raffle, could be done by the ticketing server on one or more prior to serve communication or network interfaces, using the purchaser identifiers or communications addresses of the purchasers stored in each ticket record in the database, or if there was not a purchaser or network interface compatible with the particular purchaser identifier of one or more ticket records within the data set which was the winning ticket record selected, traditional contact methods such as a traditional telephone call could be used.

The winning ticket record 8 could be selected either by use of a random number generator on the server 11, or in other cases where a non-random selection was made by some software tool programmed on the ticketing server software 17, or alternatively as is also outlined herein selection of the winning ticket record 8 could comprise the printing of paper counter foils with the ticket identifiers 4 or other information pertaining to active ticket records 8 from the ticket database 7 for the conduct of a manual draw.

Where the purchasor identifier 3 in respect of a particular purchasor and a particular bearer ticket sold in a raffle was either connected to or represented a communication address for the purchasor, the server 11 could initiate a direct communication to the purchasor indicating the status or the selection of their winning ticket. Alternatively, notification could take place in another way where the operator of the raffle and of the system of present invention would based upon the purchasor identifier 3 determine the identity of the purchasor and initiate a conventional contact in that fashion.

### Illustrative Environment and System Architecture:

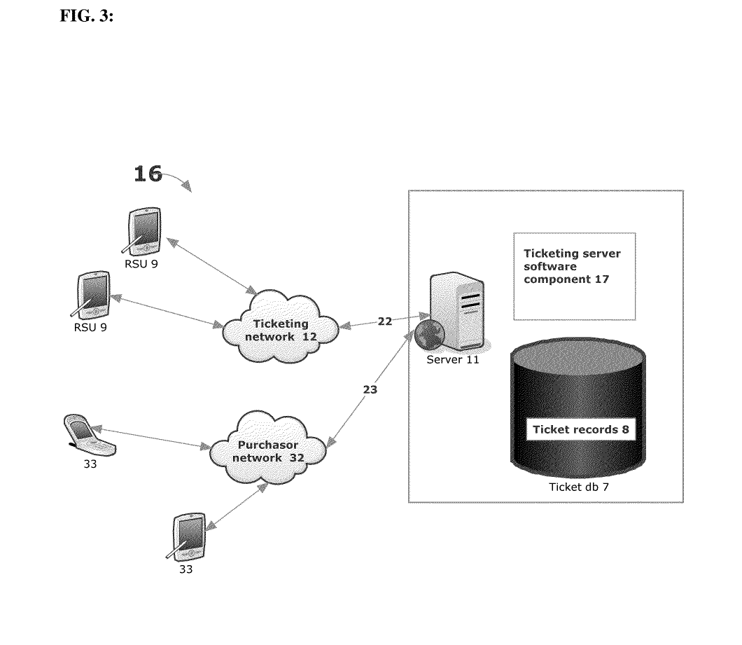

FIG. 3 shows an illustrative architecture of the overall system 16 of the present invention, in which ticket sales personnel can use raffle sales units 9, interacting with a ticketing server 11, to sell and issue bearer raffle tickets to purchasors in accordance with the remainder of the present invention. The ticketing server 11 might include various software applications to manage aspects of interaction between various components of the system 16, the server 11 or the raffle sales units 9. Software applications on the ticketing server 11 would include ticketing server software 17, responsible for the administration and handling of the method of the present invention. The server 11 would host a ticket database 7, which was accessible to the software applications thereon and which would comprise a plurality of ticket records 8 corresponding to bearer tickets which were sold in accordance with the method of the present invention. The ticket database 7 is shown here for demonstrative purposes.

The raffle sales units 9 would be connected to the ticketing server 11 via a ticketing networking 12. The ticketing network 12 could be any type of a communications network capable of communication between the ticketing server 11 and the raffle sales units 9. It could be a wide area network, local area network or otherwise. The raffle sales units 9 might be statically connected so they had constantly open communications with the ticketing server 11, or some embodiments of the system and method of the present invention could have the raffle sales units with redundancy or purpose-built software allowing for periodic or intermittent communication sessions with the ticketing server 11. For example if the ticketing network 12 were wireless and it was desired to allow for the sales of tickets on an ongoing basis even when the wireless communication was not available to the raffle sales units 9, the system 16 could allow for periodic handshaking and communication between the raffle sales units 9 and the ticketing server 11 for the sake of transmitting sold ticket particulars and other information to the ticketing server 11 for the creation of the necessary ticket records 8 in the database 7 related to tickets which were sold since the last communication.

The ticketing network 12 might be any combination of multiple different types of networks, such as cable networks, local area networks, personal area networks, wide area networks, the internet, wireless networks, ad hoc networks and mesh networks or the like.

The ticketing server 11 might house or otherwise connect to one or more data storers of various information which are required for the operation of the method of the present invention. Specifically, the embodiment demonstrated in FIG. 3 shows a ticket database 7 which was operatively connected and accessible thereto with any number of subsets of data files stored therein. As outlined in further detail elsewhere below, there are alternate embodiments of the method and the system of the present invention in which the ticketing server 11 might include a separate data storer which was a purchasor database, containing details of ticket purchasors, in addition to the storage of ticket records 8 in a freestanding database or data structure. Different types of data structures which will each accomplish the same overarching method of the present invention will be obvious to those skilled in the art of database design and are all contemplated within the scope hereof.

The architecture which is shown in FIG. 3 shows that ticketing server 11 along with two raffle sales units 9. Also shown is the ticketing network 12. These components are shown purely for demonstrative purposes and it will be understood that many different types of network architectures or system components and setups could be developed which would still accomplish the method outlined herein and all are contemplated within the scope of the present invention.

This will also be outlined elsewhere herein, raffle sales units 9 could be located in one or more physical venues for the sale of bearer tickets and in error raffle in accordance with the method of the present invention. A multilocation raffle could basically have the raffle sales units 9 located multiple venues and connected back by a consolidated ticketing network to a single ticketing server which was located either at one of the raffle venues or in a central service bureau.

Also shown in FIG. 3 is the purchasor network interface 23 of the server 11 to the purchasor network 32 by which communication can be made with the communications devices 33 of purchasors of tickets. Based on the purchasor identifiers 3 stored in ticket records in the database 7, the server 11 can transmit raffle winning or update notifications to some or all purchasors in a raffle.

### Ticketing Server:

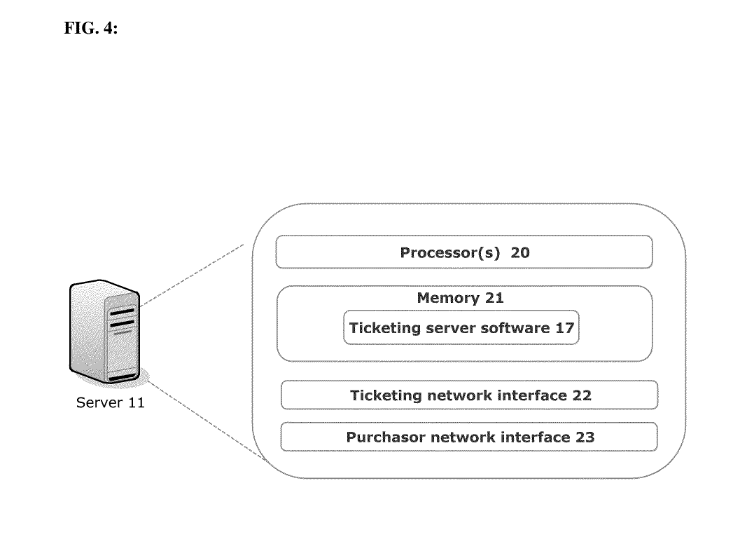

The method of the present invention on the overall architecture would be client/server in nature and would rely upon raffle sales units 9 in the field which were capable of interacting with a ticketing server 11 via a ticketing network interface 12. One or more ticketing servers 11 might be implemented in the method of the present invention—a single server or a server farm approach. FIG. 4 outlines an illustrative embodiment of a ticketing server 11 in accordance with the present invention. The server or servers 11 would each compromise one or more processors 20 and memory 21. The memory 21 might contain various software components or a series of processor instructions for use in the method of the present invention or otherwise in the operation of the ticketing server 11. Processor instructions corresponding to the ticketing server software 17 are shown stored within the memory 21.

The server 11 hosts or is operatively connected to the ticket database 7. In addition to the necessary general operating system instructions and the like the ticketing server 11 would compromise a ticketing server software component 17 which would be responsible for execution of the method of the present invention at the server and, ticketing server software component 17 might itself act as the interface between the remainder of the hardware and software of the ticketing server 11 and the ticket database 7, or the ticketing server 11 might alternatively include additional software interface to the ticket database 7 with which the ticketing server software component 17 and its various subroutines could communicate.

The ticketing server software component 17 would compromise subroutines for the purpose of administering the ticket database 7, creating and modifying ticket database transactions and ticket records in interaction with the raffle sales units 9, as well as executing searches and reporting against the ticket database 7 as might be required. The details of the operation of the ticketing server software 17 are outlined herein.

Also shown on this Figure is the ticketing network interface 22. The ticketing network interface 22 would be the necessary hardware and software components resident on or installed upon the ticketing server 11 which would allow the ticketing server 11 to communicate with the raffle sales units 9 as well as any other components in the issuance of tickets. The ticketing network interface 22 could again be by any wired or wireless interface using a network protocol allowing the ticketing server 11 to communicate with the ticketing devices 9 over a wide or local area.

Finally, this Figure also shows a purchasor network interface 23. The purchasor network interface 23 could be a software or hardware component which would enable the ticketing server 11 to communicate with purchasors using the purchasor identifiers 3 or other information stored in association with ticket records 8 in the ticket database 7. As outlined elsewhere herein there could be one or more purchasor network interfaces 23 on the ticketing server 11 depended upon the various types of networks on which it was designed to be able to communicate with purchasors. Certain embodiments of the ticketing server 11 depending upon the nature of the architecture of the system implemented in accordance with the present invention may contain more than one purchaser network interface 23, if multiple such interfaces 23 make sense from the perspective of communicating with purchasers on multiple technology platforms. The inclusion of one or more than one purchaser network interface 23 in the server 11 is contemplated within the scope of the present invention.

It may be the case if multiple purchaser network interfaces 23 were present in the server 11 that there were also multiple purchaser networks 32 in use. This will also be understood to those skilled in the art network and client/server software design. Generally speaking it is desired to provide one or more purchaser network interfaces 23 in most embodiments of the server 11 that would allow the server 11 at appropriate points in time either during the predefined sales window for a bearer raffle, or at the time of notification of a winner, to allow the server 11 to transmit notifications directly to the communications devices one or more purchasers of bearer tickets in the raffle in question.

### Ticket Database:

A key aspect of the method of the present invention, which is required for its practice, is the presence of a central ticket database 7 in which ticket records 8 which pertain to individual bearer tickets sold in accordance with the remainder of the present invention will be stored. Ticket parameters 2 would be stored in respect of each bearer ticket that was sold and would include a unique ticket identifier 4, which could be a serial number or some other unique identifier in respect of the ticket for the purpose of keying the database, as well as a purchasor identifier 3. As outlined elsewhere herein the purchasor identifier 3 could be a standalone communications address or identifier by which notification of status of outcome of a particular bearer raffle in accordance with the method of the present invention could be messaged or communicated to the purchasor of a winning ticket, or to the purchasor of any ticket in the raffle, who in the prior art methods would have needed to present the physical ticket stub for collection of a prize since the sales process was otherwise anonymous. Variations on the method of the present invention could allow for communication only with a winning ticket holder, or in other cases it may be desired to announce to all of the purchasers of tickets in a particular bearer raffle what the outcome of the raffle was in the communications addresses or purchaser identifiers 3 stored in respect of each ticket record could be used for this purpose.

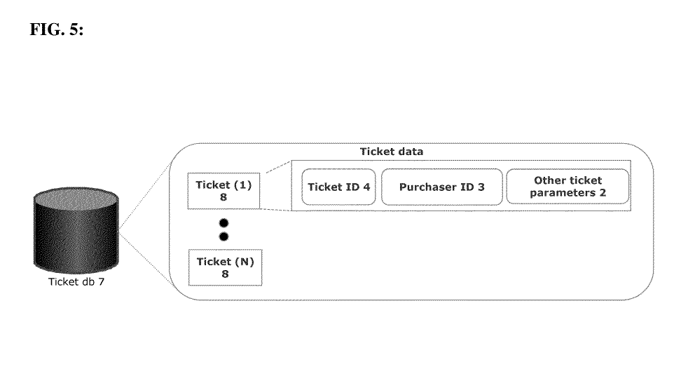

The ticket database 7 as shown in FIG. 5 contains a number of subsets of data which would be used in the execution of the method where the operation of the system of the present invention were used. Any type of a data structure capable of storing ticket parameters 2 in respect of tickets which are sold in accordance with the remainder of the present invention, including unique ticket identifiers 4 and purchasor identifiers 3 which were required for the practice of the remainder of the system and method are contemplated herein.

The ticket database 7 might be a resident on the ticketing server 11, or might alternatively be resident on or administered remotely within some type of server from a database environment which was operatively connected for communication with the ticketing server 11 of the remainder of the present invention. The database 7 might also compromise multiple databases or files rather than a single database file or structure. The particular construction or data structure of the ticket database 7 might also depend on the infrastructure design of the remainder of the system of the present invention—again the various aspects of the system, its structure and the ticket database 7 including those which are infrastructure dependent—will be understood to those skilled in the art of relational database and client server system design and are all contemplated within the scope of the present invention. It is specifically contemplated that the ticket database 7 would most likely compromise a SQL database running on the necessary database server platform, however other approaches of tools and development environments could also be used.

### Ticket Parameters:

To implement the method of the present invention, the ticket database 7 would need to comprise or include in each ticket record 8 pertaining to a bearer ticket sold in respect of a raffle, the necessary information to allow for the inclusion of that bearer ticket purchased in the raffle as well as tracking the purchasor identifier of the purchasor which is captured at the time of sale of that bearer ticket. The ticket database 7 would comprise of plurality of ticket records 8, each of which ticket record 8 corresponded to a bearer ticket which had been sold.

Referring to FIG. 5 to further outline the intended data structure or layout of the ticket database 7 in one embodiment at least, with respect to the ticket database set and the plurality of ticket records 8 stored therein. Each ticket record 8 would represent a single bearer ticket which had been sold in a raffle in accordance with the remainder of the present invention. As can be seen with respect to the first ticket record 8 outlined in the Figure there are a number of key tokens in the ticket record 8. The first item contained within that ticket record 8 is a unique ticket identifier 4. As outlined above and elsewhere this would be a serial key identifying the particular ticket for tracking within the database 7 and in accordance with the remainder of the present invention. The software components of the server 11 as well as the raffle sales units 9 would generate and/or assign these unique serial keys to each bearer ticket at the time of sale such that they could be stored within the ticket database.

In certain cases, the ticket identifier 4 could be a field on the record 8 which had multiple purposes and represented other information as well.

In addition to the unique ticket identifier 4 which would be captured or generated in respect of each ticket record 8, at the time that a set of sold ticket particulars was received in transmission from a raffle sales units 9 to the ticketing server 11, the ticket record 8 would also include a purchasor identifier 3. The purchasor identifier 3 would be captured at the raffle sales units 9 and would identify the purchasor of the ticket. As outlined in greater detail elsewhere herein, the purchasor identifier 3 is contemplated to either be some type of a communications address which could be used to directly to communicate to the purchasor if there were questions in respect of the ticket sold in bearer raffle or if it was desired to contact the purchasor to announce a raffle win, etc. The purchasor identifier 3 in this case could be an email address, a cell phone number capable of receiving SMS text messages or even a telephone number of a landline which could be used to contact the purchasor in a traditional fashion.

Ticket parameters 2 would also be stored in the ticket record 8 which would include other parameters or details of the bearer ticket which had been sold—for example the price at which the ticket was sold, numbers or applicable gaming parameters where there were variable rules in the raffle, whether or not certain optional or progressive or side bets were placed if they were available within the raffle, etc. Any necessary data tokens of fields which were necessary to calculate and/or operate such a bearer ticket raffle will be understood by those skilled in the art of game design and are contemplated within the scope of the present invention.

Another specific data field which might be stored within a ticket record 8 in the ticket parameters 2 might be a validation code. The validation code as outlined in further detail herein could be generated by the remainder of the system during the sale of the ticket and/or could be manually selected or entered by the user of the raffle sales unit at the time that the ticket was sold—in any event, the issuance of a validation code which could be used as a double verification of the ownership of the ticket in awarding winnings is outlined elsewhere herein and if such a validation code were generated or issued at the time of sale of a particular bearer ticket in a bearer ticket sale transaction, that validation code 15 could be stored in or in association with the respective ticket record 8 in the database 7.

### Purchasor Identifier:

As outlined elsewhere above, the key data token which is captured with respect to each bearer ticket sold in accordance with the method of the present invention, in addition to the basic ticket parameters 2, is a purchasor identifier 3 which is captured in respect of the purchasor of each bearer ticket which is sold. The purchasor identifier 3 is intended to be effectively a communications address which the system of the present invention could transmit notifications or facilitate communication with the purchasor of a particular bearer ticket when a winner is chosen or other notification as required. In that circumstance the purchasor identifier 3 which could be captured either by manual data entry, scanner or otherwise at the raffle sales units 9, could be any type of a communications address such as an email address, a telephone number for manual telephone call notification, instant messaging address or the like—any type of a communications address which could be used in conjunction with an available purchasor network interface to communicate with the purchasor of the bearer ticket.

The purchasor identifier 3 might also alternatively or additionally comprise a cross-linking key to a purchasor record in a purchasor database or a purchasor table stored separately accessibly to the ticketing server 11, in which additional details or information of the purchasor might be stored.

### Raffle Sales Unit:

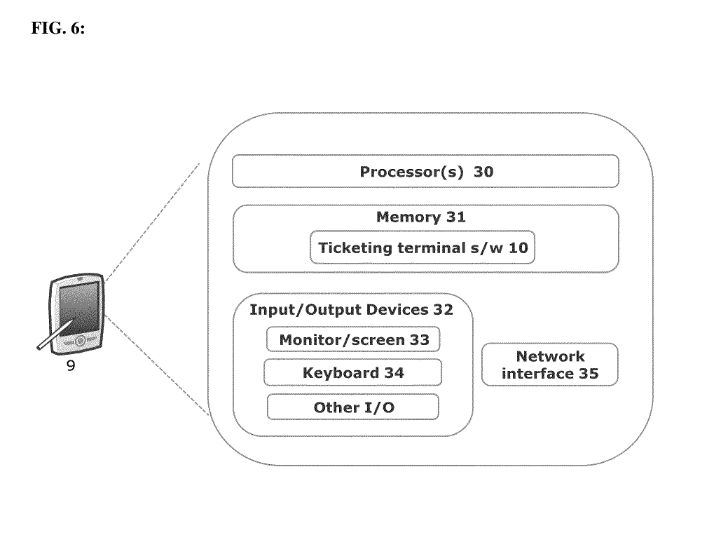

FIG. 6 is a schematic representation of a raffle sales unit 9 in accordance with the present invention. The raffle sales unit 9 includes one or more processors 30 and a memory 31. Similar to computer memory on the ticketing server 11, the memory on the raffle sales unit 9 might include various types of processor instructions either for assistance in the execution of the method of the present invention or for other activities to be undertaken with the raffle sales unit 9. The memory 31 would include a raffle sales software component 10 which is installed for the purpose of communicating with the ticketing server 11, and accomplishing the remainder of the method by providing the operator interface and enabling the operator of the raffle sales unit 9 to interact with the purchasor and to issue inside bearer tickets in accordance with the remainder of this system and method of the present invention.

The raffle sales unit or devices 9 might be custom-built hardware, or with appropriate modifications undertaken to the raffle sales software 10, standard hardware such as smart phones, tablet computers or other devices could be used to issue bearer ticket in accordance with remainder of the present invention. All such approaches are contemplated within the scope hereof. Pre-existing raffle sales unit 9 hardware could be repurposed with modified software for use in accordance with the remainder of this system and method of the present invention or a purpose built hardware could also be used.

The raffle sales unit 9 which is shown in this Figure also includes one or more input and output devices 32. This particular Figure shows the present of a screen 33, some type of a keyboard or other data entry means 34 by which the operator of the device 9 could interact with and enter information for capture. In some implementations, the raffle sales unit 9 might also include a clock, location sensor or the like. Also present in the raffle sales unit 9 would be a ticketing network interface 35 by which the raffle sales unit 9 could communicate with the ticketing server 11 for the purpose of the transmission of sold ticket particulars related to bearer ticket sales transactions completed on that raffle sales unit to the ticketing server 11, for the purpose of creation of ticket records 8 within the ticket database 7 with respect to tickets being sold by that raffle sales unit 9.

The ticketing network interface 35 could either be wired or wireless. It would be capable of communicating with the ticketing network 12. The ticketing network interface 35 might use any type of network communication protocol depending upon the network infrastructure in question. In some implementations, the ticketing network interface 35 might be intended to send and receive data from the network wirelessly, and in other cases a wired network connection might be used. Some deployments of ticketing network 12 in accordance with the remainder of the present invention could foreseeably include both hard wired as well as wireless raffle sales units 9.

### Purchasor Network Interface:

The final potential component in many embodiments of the ticketing server 11 would be at least one purchaser network interface. The purchaser network interface 23 would be the necessary combination of hardware and software by which the ticketing server 11 could communicate with communications devices of purchasers using the purchaser identifiers 3 provided at the time of bearer ticket purchase. For example, the purchaser network interface 23 could be an email gateway, an SMS component which allowed to dispatch SMS messages to SMS telephone numbers etc.

The purchaser network interface 23 could communicate via the
1. The method of claim 2 wherein the ticketing server further comprises at least one purchasor network interface for communication on at least one purchasor communications network, by which the ticketing server can transmit messages to the communications devices of purchasors using the purchasor identifiers provided at the time of ticket purchase.
2. The method of claim 4 wherein the step of using the purchasor identifier associated with the winning ticket record to identify and notify the purchasor of their winning the bearer raffle comprises transmitting a winning ticket notification to the purchasor associated with the winning ticket record using the purchasor identifier contained in the winning ticket record, via the corresponding purchasor network interface.
3. The method of claim 4 wherein the number of purchasor network interfaces is one.
4. The method of claim 4 wherein the number of purchasor network interfaces is more than one.

### Ticketing Server Software Component:

The ticketing server software 17 in the software resident on or accessible to the ticketing server 11 would be key to the performance of the present method. It is specifically contemplated that the functions of the ticketing server software 17 would include creation and administration of ticket records 8 within the database 7, interaction with the ticket database 7 and other data structures accessible to the ticketing server 11 for the purpose of conduct of the method of the invention, interaction with the raffle sales units 9 via the client raffle sales software thereon for the purposes of receiving sold ticket particulars transmitted from the raffle sales unit 9 for the creation of ticket records 8 within the database 7, as well as many other query or reporting functions which could be conceived. Each software functional module could be freestanding within the memory or storage of the ticketing server 11, or alternatively although the functions could be functions of a consolidated software program—any such approaches obviously understood to be contemplated within the scope of the present invention.

Overall, the creation and administration of ticket records 8 within the ticket database 7 will be conducted by a database administration module. The database administration module would be responsible for the administration, creation and modification of ticket records 8 stored within the ticket database 7. Upon receipt at the ticketing server 11 of a transmission containing a set of sold ticket particulars related to a bearer ticket sale from a raffle sales unit 9, the database administration module could parse that transmission or information in the necessary details required to create a corresponding ticket record 8 within the ticket database 7. It is specifically contemplated that a separate freestanding ticket record 8 would likely be created with respect to each bearer ticket sold in accordance with the method.

It may also be the case that certain embodiments of a ticket database 7 could be designed which would allow for a single ticket record 8 to represent more than one ticket having been sold to a single purchasor and though such a purchase are understood to be within the scope of the present invention. As well, many different types of database administration and programming approaches will be understood to those skilled in the art of database programming and again all approaches are contemplated herein.

In addition to the overall database administration module and related subroutines, responsible for interfacing with the data structure of the ticket database 7 and the other aspects of the software and any user interface on the ticketing server 11 or related and connected raffle sales units 9, the processor instructions accessible to the ticketing server 11 would also include the necessary software to allow for communication by the ticketing server 11 with the raffle sales units 9 via the ticketing network 12. These processor instructions would also include the necessary software to allow for communication with purchasors in certain embodiments of the method where the ticketing server 11 might include at least one purchasor network interface. In embodiments of the ticketing server 11 which did not include a direct purchasor network interface, and rather the communication with winning bearer ticket holders or purchasors was done in traditional ways, a purchasor network interface may not be necessary and related processor instructions on the ticketing server 11 could also be overlooked.

The ticketing server software 17 might also include a random number generator or other necessary software instructions to enable the selection of winning ticket records from active ticket records with respect to a particular raffle in the ticket database 7. If a manual drive was the preferred approach rather than the use of a software based random number generator, a particular implementation of the ticketing server software components 17 might interact with a counter foil printer connected to the ticketing server 11 and the software components 17 could include the necessary additional query and reporting components to allow for the printing of counter foils corresponding to active ticket records 8 in the ticket database 7 with respect to a particular raffle and for the purpose of conduct of a manual draw. Once a winning ticket record 8 was selected in an embodiment with a manual draw, a user interface of the ticketing server 11 could be used to conduct the necessary final communication or verification with purchasors of the winning ticket in the bearer raffle corresponding to that bearer ticket record in accordance with the remainder of the present invention.

Certain embodiments of the method of the present invention involve a verification step based upon the purchasor identifier 3 which is captured with respect to a purchasor of a particular bearer ticket. When a purchasor identifier 3 is captured with respect to a purchasor, in certain embodiments of the method it is conceived that a data validation will take place against a purchasor database stored accessible to the ticketing server 11. The additional conduct of validation, extraction and storage of purchasor details to the purchasor database or purchasor records in a related data structure could also be an added software function required in certain embodiments of the ticketing server component 17 and that is a gain contemplated within the scope of the present invention.

### Raffle Sales Software:

Insofar as the method of the present invention is built around the ability to remotely sell bearer tickets in a bearer raffle within the network environment, the raffle sales units 9 would need to include a raffle sales software program 10 which was capable of interacting with the remainder of the system of the present invention.

The basic requirements of the raffle sales software 10 would be the need to interact with the software and hardware components resident on or connected to the raffle sales unit 9 at the appropriate time to read or capture ticket parameters 2, purchasor identifiers 3 and other information from the operator in respect of a bearer ticket or tickets being sold, and to provide for the ability to transmit sold ticket particulars, and assign unique ticket identifiers, in respect of bearer ticket sales transactions back to the ticketing server 11.

It is primarily contemplated that the raffle sales software 10 would be a freestanding local application on the raffle sales unit 9—by creating a freestanding local application for use on the raffle sales unit 9 there would be numerous benefits including the fact that the raffle sales unit 9 would then not need to have constant network connectivity to the ticketing network 12 since it could store an offline subset of captured and generated sold ticket particulars for periodic upload when the network connection was available to the server 11 and the ticket database 7.

### Validation Code:

Another permutation of the method of the present invention which is specifically contemplated would include the generation or assignment of a validation code to a bearer ticket and a bearer ticket sales transaction when it is generated or sold. That validation code 15 would then be stored in the ticket record 8 corresponding to that ticket and could be used for querying or validation purchases with the purchasor if they were selected as the winner.

A validation code 15 could or would be provided to the purchasor of the ticket as a part of the receipt process—if a printed receipt was provided or even an email or receipt message to confirm the ticket purchase was provided, the validation code 15 corresponding to the purchased tickets or ticket could also be provided so that upon receiving communication from the system or from the vendor of a particular bearer ticket or bearer raffle of being selected as the winner of the bearer raffle at the present invention, the purchasor could also be requested to provide a corresponding validation code 15 which matched the selected winning ticket record 8—if the validation code 15 was not available or could not otherwise be provided this could provide some evidence of tampering or theft of the ticket particulars. There would be many different ways of implementing this type of a validation system and all are contemplated within the scope hereof.

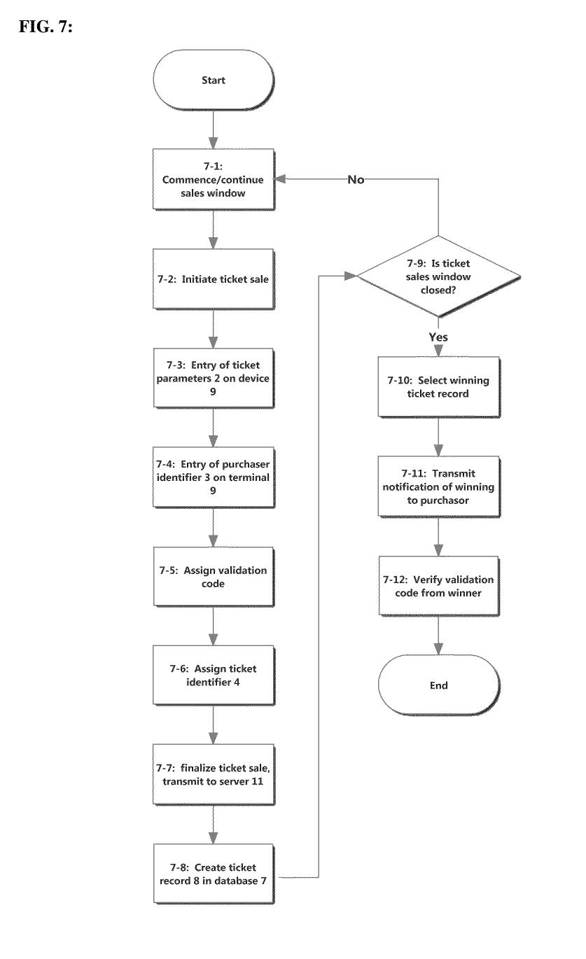

FIG. 7 is a flowchart demonstrating the steps associated with one embodiment of a method in accordance with the present invention with the addition of a validation code security layer to the method. FIG. 7 shows the steps of this method starting at step 7-1 which is the commencement or continuation of the ticket sales window in a particular bearer raffle. As outlined with respect to the method shown in FIG. 2, step 7-2 shows the initiation of a particular bearer ticket sales transaction—this would comprise a purchasor working with the operator of a raffle sales unit 9 operatively connected to the remainder of the system 16 of the present invention for the purchase of purchasing a bearer ticket. Bearer ticket parameters 2 would be selected or inputted on the raffle sales unit 9, which might include ticket pricing, number of numbers in a particular draw in which it was desired to participate, or other betting of conditions.

In addition to the entry of basic ticket parameters 2 under the raffle sales unit 9, shown at step 7-3, the operator would also need to enter the purchasor identifier 3 of the purchasor—this could either be a communication address or an identifier which was used to singly identify the purchasor or link to a purchasor record stored elsewhere in the system—this is shown at step 7-4.

The next step in the method of the present invention would be the assignment of a validation code 15 to the particular ticket in question. The validation code 15 could be a random number generated by a random number generator within the raffle sales software 10 on the raffle sales unit 9, or the validation code could also be selected and entered by the operator. Validation code assignment to the ticket is shown at step 7-5. A unique ticket identifier 4 would also be selected or assigned to the ticket, shown at step 7-6, and the ticket sale could then be finalized by transmission to the ticketing server 11 of the sold ticket particulars including the ticket parameters 2, the purchasor identifier 3, the validation code 15 as well as the ticket identifier 4. All of that information could be used to create a ticket record 8 within the ticket database 7 which corresponded to the particular bearer ticket which was sold and the particular bearer ticket sales transaction. This is shown at steps 7-7 and 7-8.

Shown at step 7-9 in this Figure is a logic determination of the closure of the ticket sales window in the particular bearer raffle in question. If a ticket sales window closes, the raffle sales units 9 and the ticketing server 11 will not allow for the sale of any more tickets. If the bearer raffle sales window is still open, more tickets and more ticket sales transactions can still be generated. If the ticket sales window has closed and the raffle is completed, a winning ticket record 8 is selected, shown at step 7-10. The notification of the winning ticket record to its purchasor, using the purchasor identifier 3 is shown at step 7-11. In this circumstance, the purchasor being identified of their winning and the purchase of the winning bearer raffle ticket, shown at step 7-11, would need to verify the proper validation code 15, which would have been provided to them at the time of the sale of the bearer ticket and is stored in the ticket record 8.

Verification of the validation code is shown at step 7-12, in order to claim the raffle prize. If the notified purchasor did not possess the validation code 15, then additional rules could be triggered in the contest to either find an alternative verification method to verify the identity or entitlement of the winner in question, or to re-award the prize. In instances of the method of the present invention where the raffle sales unit 9 included a printer and was being used to print a ticket stub for physical delivery to the purchasor, the printing of the ticket stub would take place within the context of step 7-7 in this particular Figure, being the finalization of the ticket sale once the validation code, ticket identifier and purchasor identifier have been captured or assigned along with the ticket parameters.

### Capturing Additional Purchasor Data:

A final variation in the approach of the method of the present invention which is important in offering enhanced bearer raffle capability is the option to capture additional purchasor data at the raffle sales unit 9 at the time of a bearer ticket sales transaction. The ability to capture additional purchasor data is important from the standpoint of offering enhanced flexibility in the types of side bets, add-ons or other wagers and fundraising options which could be offered for sale with a traditional anonymous bearer ticket, as well as most importantly to allow over time for the capture and validation of a database of additional purchasor data which can be used by the operator of the bearer raffle or raffles for marketing or other purposes. One specific variation on the underlying bearer raffle sales method of the present invention in which a purchasor identifier is captured and stored along with the remainder of a ticket record 8 in the ticket database 7 with respect to a bearer ticket sold is the desire to be able to sell a longer term raffle ticket as an add-on along with the bearer ticket. For example, often times a longer term or higher value raffle requires the capture of identification from a purchasor of the ticket such as their name, address, age etc. This is additional purchasor data which it might be desired to capture in the context of a bearer ticket raffle in accordance with the present invention, if it was desired to sell a longer term or higher value raffle ticket or side bet participation requiring the capture of identification or other additional purchasor data from a purchasor of a bearer ticket. The software and method of the present invention could be modified to allow for the software 10 on the raffle sales unit 9 to capture additional purchasor data such as this from the operator, by manual data entry, scanning or other data entry or capture methods, and this additional purchasor data, which would allow for the sale of a longer term or extended raffle alongside a bearer ticket, could be stored in or in relation to the ticket record 8 corresponding to the bearer ticket sales transaction in question.

There are many different types of additional purchasor data which it might be desired to capture in accordance with the method of the present invention. Basic types of additional purchasor data might include names, addresses and other vital statistics pertaining to a purchasor—including age etc. Payment methods might also be captured for storage and subsequent use in other sales transactions using the system of the present invention, subject to the implementation of appropriate security measures on the storage and use of that information.

Additional purchasor data validated, captured and stored might also include purchasor preferences for use in bearer ticket sales transactions—for example desired gaming parameters, preferred ticket price or participation levels etc., which would allow for the streamlined sale of enhanced volumes of bearer tickets in future raffles to the purchasor using this type of additional purchasor data stored in association with their purchasor identifier.

### Side Bets and Extended Raffles:

The types of side bets or extended raffles which could be offered for add-on sale in bearer ticket transactions in accordance with the remainder of the present method is varied. Many types of add-on fundraising bets or wagers, or even the sales of products or services that required purchasor identification or other additional purchasor data, could all be sold, individually or in aggregate, as add-ons in accordance with the present invention. All such types of add-on or cumulative products and services sales are contemplated within the scope hereof.

Different types of add-on sales along with a bearer ticket in a bearer raffle in accordance with the underlying method might require different types of additional purchasor data to be captured. The types of additional purchasor data captured from a purchasor in a sales transaction in accordance with the present invention could be selected or identified based on the type of add-on sales being made, or else there might be one or more standardized purchasor validation and data capture profiles programmed on the system of the present invention which would allow for the standardized capture of additional purchasor data, rather than capturing only fields or data tokens required by particular types of add-on sales. Both such approaches are contemplated within the scope of the present invention.

In addition to the possibility of variable types of additional purchasor data being captured for use in bearer ticket sales transactions in accordance herewith it will also be understood that the number of add-on sales which could take place in conjunction with a bearer ticket transaction could vary, from one to many. One user of the system of the present invention might offer only a single type of an add-on raffle or side bet etc. for sale, where other implementations of the system might allow the operator of the raffle sales unit 9 to sell more than one add-on wager, product or service to the purchasor of a bearer ticket in accordance with the method.

It is also specifically contemplated that one particular type of add-on which could be sold to a purchasor of a bearer ticket in accordance with the remainder of the present method would be a ticket for participation in a longer term raffle—ie. a raffle or fundraising game which was being sold for a longer period of time than the sale window assigned to the specific bearer ticket raffle in question. For example, a purchasor of a bearer ticket in a venue-based cash 50/50 draw might also purchase a ticket in a longer term prize raffle—such as a home lottery or other prize raffle as is often done in charity fundraising contexts. The ability to validate, capture and store additional purchasor data necessary for the sale and function of those longer term or extended add-on raffle products and the like is the key aspect of the functionality of these embodiments of the method of the present invention—where the capture of a purchasor identifier in respect of a particular ticket record 8 in the ticket database 7 provides enhanced functionality for the administration of the bearer ticket raffle, the capture and use of additional purchasor data from the purchasor for the purpose of cross-selling other types of products requiring additional purchasor data will allow for enhanced sales of all of these types of fundraising or raffle products. Additionally, the capture of the additional purchasor data to a profile database containing purchasor records will allow for quicker validation of the purchasor in future purchases and streamlining of the data capture process for additional purchasor data as well.

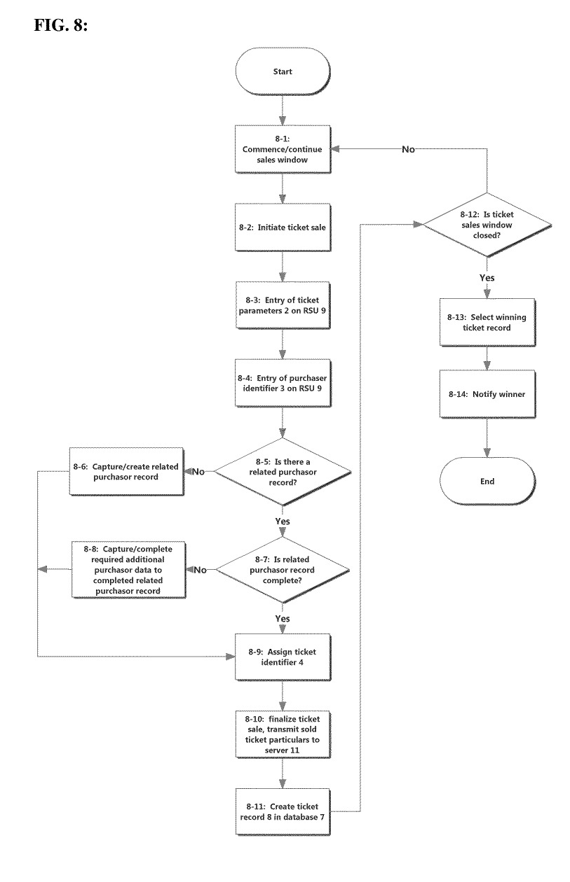

FIG. 8 shows a further embodiment of the method of the present invention in which additional purchasor data is captured, validated and stored. The commencement or continuation of a ticket sales window of a particular bearer raffle is shown at step 8-1. In respect of the sale of an individual bearer ticket, shown at 8-2, the first step could be the entry of various ticket parameters 2 on the raffle sales unit 9 by the operator. This is shown at step 8-3. In addition to ticket parameters 2, the operator of the raffle sales unit 9 would manually enter or otherwise capture a purchasor identifier 3, shown at step 8-4. The purchasor identifier 3 would also be used as a serial key to identify the purchasor themselves. The entry of ticket parameters 2 and purchasor identifier 3 could occur in either order.

Following capture of a purchasor identifier 3, the raffle sales unit 9 via its software 10 and components would validate the captured purchasor identifier 3 against a purchasor database 42 stored within or accessible to the ticketing server 11. Database validation is a concept understood to those skilled in the art—basically, the system would check the contents of the purchasor database 42 to confirm if there was a purchasor record 40 therein which corresponded to the purchasor. This validation is shown at Step 8-5. Based on this method and embodiment, purchasor records 40 would be created for each new purchasor, so a repeat purchasor within a particular raffle, or a repeat purchasor in a subsequent raffle using the same purchasor database 42 would have a record 40 therein.

If at Step 8-5 it is determined that a purchasor record 40 already exists in the purchasor database 42, the next data validation which will be done is to test the contents of that related purchasor record 40 to confirm that all of the desired or necessary additional purchasor data for the purpose of the system or the raffle in question is contained in that record 40. If the purchasor record 40 corresponding to the captured purchasor identifier 3 is validated as being complete, the remainder of the bearer ticket sales transaction, including the selection of any additional add-on raffle sales or parameters can be completed and the necessary ticket record 8 created within the ticket database 7. This data testing step is shown at 8-7.

If it is determined that the purchasor record 40 corresponding to the captured purchasor identifier 3 is incomplete—i.e. that additional purchasor data is required to be captured for the purpose of the raffle or the system and database—the raffle sales unit 9 will allow for the entry of that additional purchasor data and transmission for storage in the related purchasor record 40—shown at Step 8-8. As a result of these data validation steps, a purchasor profile is created or refreshed on the system and stored in the purchasor record 40, which allows for the side selling of raffles or other addon products or services which require something more than most basic purchasor validation or removal of anonymity.

The remainder of the ticket transaction can be completed. In this particular case the assignment of a ticket identifier 4 is shown at step 8-9. No validation code assignment is shown in this particular embodiment of the method although the assignment of a validation code as outlined in FIG. 7 could also be done here. Following the assignment of a unique ticket identifier 4 shown at step 8-9, the ticket sale can be finalized and transmitted to the server 11. This is shown at 8-10.

Upon receipt of a transmission of a ticket sale, including ticket parameters 2, purchasor identifier 3 and a ticket identifier 4, along with any captured new or additional purchasor profile data, a ticket record 8 can be created in the database 7, shown at step 8-11. A purchasor profile record can also be updated in the ticket database 7 at the same time.

Step 8-12 shows a logic test of whether or not the ticket sales window is closed. If the ticket sales window is closed a winning ticket is selected and the notification to the winning purchasor is transmitted based upon the purchasor identifier 3 stored in the ticket record 8 with respect to the particular ticket sold. Additional information stored within a purchasor record within the purchasor database 42 or elsewhere might also be used in the creation or transmission of a winning notification, shown at 8-14.

### Multiple Raffle Venues:

As outlined elsewhere above, it is specifically contemplated that the network architecture of the present invention could accommodate the use of a single ticketing server 11, along with multiple raffle sales units 9 which were located in multiple vendors—thus allowing for the sale of bearer raffle tickets in multiple locations within the defined sales window. This would be possible if the ticketing network and the ticketing network interfaces of the various hardware components allowed for longer-range communication between the raffle sales units 9 and the ticketing server 11. Sales taking place in either a single or multiple raffle venue approach are both contemplated within the scope hereof. It would also be possible to implement an alternate architecture of the system of the present invention where a ticketing server 11 was located in each venue, and the ticketing servers 11 and the multiple venues shared information about the assignment of unique ticket identifiers so that ticket sales could be conducted in multiple venues each with their own freestanding server and at appropriate points in time data could be replicated or verified between the servers 11 to allow for the remainder of the method of the present invention to be effectively practised.

### Central Server and Service Bureau:

In addition to the possibility to offer multiple venue raffle sales with a single server two a raffle provider, wherein raffle sales units 9 could be used at multiple physical venues or locations are connected back via a wide area ticketing network to a single ticketing server 11 located either in one of the venues or in some remote third location, it is also conceivable that the method of the present invention could be practised in a way that a single central server 11 was used to provide ticketing database and server support for raffle sales units 9 of multiple providers at multiple locations whereby the server 11 could effectively capture soul ticket particulars in respect of bearer tickets sold for multiple raffles at the same time. This type of an approach will be understood to those skilled in the art of network and client/server development and is also contemplated within the scope hereof.

Thus, it is clear that the described embodiments provide an enhanced bearer raffle system and method with commercial utility and market attractiveness.

In addition, it will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

1. A method of conducting a bearer raffle, said method comprising:
a) providing a ticketing server comprising:
i. a ticket database, said ticket database comprising a plurality of ticket records each corresponding to a bearer ticket sold in a bearer raffle and including a unique ticket identifier, a purchasor identifier corresponding to the purchasor of the bearer ticket, and ticket parameters of the bearer ticket sold;
ii. a ticketing network interface for communication with at least one raffle sales unit;
iii. ticketing server software for administering the ticket database and managing communications via the ticketing network interface;
b) providing at least one raffle sales unit, comprising an operator interface, a network interface for communication with the ticketing server, and raffle sales software for operators to transact the generation and sale of bearer tickets to purchasors;
c) selling bearer tickets in a bearer raffle during a defined sales window by, in respect of each bearer ticket sold:
i. using a raffle sales unit:
selecting ticket parameters for the bearer ticket;
capturing a purchasor identifier in respect of the purchasor;
assigning a unique ticket identifier to be associated with the bearer ticket sold; and
transmitting the ticket parameters and purchasor identifier in association with the ticket identifier, being the sold ticket particulars, to the ticketing server;
ii. on the ticketing server, creating a ticket record in the ticket database in respect of each set of sold ticket particulars received;
d) following the closure of the defined sales window for the bearer raffle, selecting a winning ticket record from the ticket records related to the bearer raffle stored in the ticket database; and
e) upon selection of a winning ticket record, using the purchasor identifier associated with the winning ticket record to identify and notify the purchasor of their winning the bearer raffle.

2. The method of claim 1 wherein the purchasor identifier is a communications address corresponding to a communications device of the purchasor.

3. The method of claim 2 wherein the communications address captured in respect of a ticket is selected from the group of the following communications coordinates for purchasors:
a) SMS address;
b) voice telephone number; and
c) email address.

4. The method of claim 2 wherein the ticketing server further comprises at least one purchasor network interface for communication on at least one purchasor communications network, by which the ticketing server can transmit messages to the communications devices of purchasors using the purchasor identifiers provided at the time of ticket purchase.

5. The method of claim 4 wherein the step of using the purchasor identifier associated with the winning ticket record to identify and notify the purchasor of their winning the bearer raffle comprises transmitting a winning ticket notification to the purchasor associated with the winning ticket record using the purchasor identifier contained in the winning ticket record, via the corresponding purchasor network interface.

6. The method of claim 4 wherein the number of purchasor network interfaces is one.

7. The method of claim 4 wherein the number of purchasor network interfaces is more than one.

8. The method of claim 1 wherein the step of selling a bearer ticket via a raffle sales unit further comprises capturing additional purchasor data in respect of the purchasor via the operator interface of the raffle sales unit, and storing said additional purchasor data in association with the related ticket record.

9. The method of claim 1 wherein the purchasor identifier is captured by manual entry by the operator of the raffle sales unit.

10. The method of claim 1 wherein the raffle sales unit includes a scanner.

11. The method of claim 10 wherein the purchasor identifier is captured on the raffle sales unit using the scanner to scan a physical identifier of the purchasor.

12. The method of claim 11 wherein the physical identifier of the purchasor scanned is a personal identification of the purchasor.

13. The method of claim 1 wherein the sale of a bearer ticket further comprises the printing of a ticket receipt on the raffle sales unit for provision to the purchasor.

14. The method of claim 4 wherein the sale of a bearer ticket to a purchasor further comprises the transmission of a ticket receipt to a communication device of the purchasor via the at least one purchasor network interface.

15. The method of claim 1 wherein the selection of a winning ticket record comprises using a random number generator to randomly electronically select a winning ticket record from the active ticket records in the ticket database in respect of the bearer raffle.

16. The method of claim 1 wherein the selection of a winning ticket record comprises printing a counterfoil using a printer connected to the ticketing network interface for each active ticket record in the ticket database related to the bearer raffle, from which a physical draw can be made of a winning ticket identifier.

17. The method of claim 1 wherein the selection of a winning ticket is made from all of the ticket records in the ticket database for the raffle.

18. The method of claim 1 wherein the selection of a winning ticket is made from a subset of the ticket records in the ticket database for the raffle.

19. The method of claim 18 wherein the selection of the subset of ticket records is made based on the ticket parameters captured and stored in the ticket records in respect of individual tickets sold.

20. The method of claim 1 wherein in respect of a bearer ticket sold to a purchasor, a validation code is generated along with generation and association of the ticket identifier, provided to the purchasor at the time of purchase, and stored to the corresponding ticket record, whereby the validation code can be requested from the winning purchasor when identified or notified of their winning the bearer raffle.

21. The method of claim 1 further comprising the optional sale of at least one add-on ticket in an add-on raffle to a purchasor along with a bearer raffle ticket, wherein:
a) said optional sale of at least one add-on ticket is selectable and fulfillable by the raffle sales unit;
b) ticket records are generated and stored in the ticket database in relation to the add-on tickets sold.

22. The method of claim 21 wherein no additional purchasor data is required to be captured beyond the purchasor identifier in respect of the at least one add-on ticket in an add-on raffle.

23. The method of claim 21 wherein additional purchasor data is required to be captured in respect of the sale of at least one add-on ticket in an add-on raffle.

24. The method of claim 21 wherein at least one add-on raffle is a bearer raffle.

25. The method of claim 21 wherein at least one add-on raffle is not a bearer raffle.

26. The method of claim 21 wherein at least one add-on raffle is a long term raffle, the window for sales of which extends beyond the defined sales window of the bearer raffle.

27. The method of claim 1 wherein the ticketing server is locally located in the venue in which the bearer raffle ticket sales are taking place during the defined ticket sales window.

28. The method of claim 1 wherein the ticketing server is remotely located from the venue in which the bearer raffle ticket sales are taking place during the defined ticket sales window.

29. The method of claim 28 wherein the ticketing server receives sold ticket parameters from raffle sales units in a single venue.

30. The method of claim 28 wherein the ticketing server receives sold ticket parameters from raffle sales units in multiple venues.

31. The method of claim 28 wherein the ticketing server receives sold ticket parameters in respect of a single bearer raffle.

32. The method of claim 28 wherein the ticketing server receives sold ticket parameters in respect of more than one bearer raffle.
